(19) United States
(12) Patent Application Publication
(10) Pub. No.: US 2021/0272386 A1
(43) Pub. Date: Sep. 2, 2021

(54) INFORMATION PROVIDING METHOD, INFORMATION PROVIDING SYSTEM, AND TERMINAL

(71) Applicant: TOYOTA JIDOSHA KABUSHIKI KAISHA, Toyota-shi (JP)

(72) Inventors: Yusuke HARA, Tokyo (JP); Mutsumi ABE, Tokyo (JP); Masaki MIYAGAWA, Tokyo (JP); Kota OKAMOTO, Tokyo (JP); Satoshi KATO, Aichi-ken (JP); Takaaki HAGA, Tokyo (JP)

(73) Assignee: TOYOTA JIDOSHA KABUSHIKI KAISHA, Toyota-shi (JP)

(21) Appl. No.: 17/186,206

(22) Filed: Feb. 26, 2021

(30) Foreign Application Priority Data
Mar. 2, 2020 (JP) 2020-034890

(51) Int. Cl. G07C 5/00; G07C 5/08; B60W 40/09

(52) U.S. Cl. CPC G07C 5/008; B60W 40/09; G07C 5/0841

(57) ABSTRACT

An information providing method includes: transmitting, by a management server, content information indicating contents to a terminal; storing, by the terminal, the content information transmitted from a management server in a storage; transmitting, by the terminal, the content information stored in the storage to an information processing device of a vehicle when communication is established with the vehicle; receiving, by the information processing device, the content information transmitted from the terminal; and outputting, by the information processing device, the received content information.

### CROSS-REFERENCE TO RELATED APPLICATION

This application claims priority to Japanese Patent Application No. 2020-034890 filed on Mar. 2, 2020, incorporated herein by reference in its entirety.

### BACKGROUND

### 1. Technical Field

The present disclosure relates to an information providing method, an information providing system, and a terminal.

### 2. Description of Related Art

There is known a method for collectively acquiring pieces of data from road users. For example, Japanese Unexamined Patent Application Publication No. 2018-110400 (JP 2018-110400 A) discloses that mobile devices whose pieces of data are intended to be acquired are selected depending on connection statuses of the mobile devices in a mobile radio network.

There is known a technology for controlling an uplink traffic from vehicles in a cell by using edge computing. For example, Japanese Unexamined Patent Application Publication No. 2019-179993 (JP 2019-179993 A) discloses a technology for controlling an uplink traffic from vehicles in a cell defined around a base station by predicting a traffic amount in the cell by using edge computing.

### SUMMARY

When a plurality of vehicles communicates with one management server, a communication load increases between the vehicles and the management server.

For example, the vehicles sequentially transmit pieces of positional information to the management server, and the management server transmits pieces of predetermined data to the vehicles based on the pieces of positional information. In this case, a considerable amount of data is transmitted in the communication. Therefore, a traffic indicating a data amount increases in a communication network between the vehicles and the management server. In particular, the traffic considerably increases when the amount of contents of data to be transmitted from the management server to each vehicle is larger than a predetermined amount.

In this case, a processing load on the management server increases because the pieces of positional information are transmitted from the vehicles to the management server. Further, the degree of real-time communication between the vehicle and the management server decreases.

In the technologies disclosed in JP 2018-110400 A and JP 2019-179993 A, the increase in the traffic between a plurality of vehicles and one management server is not taken into consideration. In the technology disclosed in JP 2019-179993 A, determination is made whether to permit transmission of data from each vehicle based on a result of prediction of the traffic and the amount of data to be transmitted from the vehicle. In the technology disclosed in JP 2019-179993 A, the traffic between the vehicles and the management server is not reduced when the management server transmits pieces of data to the vehicles.

In the technologies described above, it is difficult to reduce the traffic between the vehicles and the management server when the management server transmits pieces of data to the vehicles.

The present disclosure provides an information providing method, an information providing system, and a terminal in which a traffic between vehicles and a management server can be reduced when the management server transmits pieces of data to the vehicles.

A first aspect of the present disclosure relates to an information providing method to be executed in an information providing system including a management server, a terminal including a storage, and an information processing device in a vehicle. The information providing method includes transmitting, by the management server, content information indicating contents to the terminal, storing, by the terminal, the content information transmitted from the management server in the storage, transmitting, by the terminal, the content information stored in the storage to the information processing device of the vehicle when communication is established with the vehicle, receiving, by the information processing device, the content information transmitted from the terminal, and outputting, by the information processing device, the received content information.

The management server transmits the content information indicating contents to the terminal. The terminal stores the content information transmitted from the management server in the storage. When communication is established with the vehicle, the terminal transmits the content information stored in the storage to the information processing device of the vehicle. The information processing device receives the content information transmitted from the terminal, and outputs the received content information. According to the first aspect, when data is transmitted from the management server to the vehicle, there is no need for direct communication between the management server and the vehicle. Thus, the traffic between the vehicle and the management server can be reduced.

In the first aspect, the content information stored in the storage of the terminal may be available in an area where the terminal is arranged.

According to the configuration described above, after viewing the content information, the user of the vehicle can promptly use the content information in a facility or the like in the area.

In the first aspect, the content information may be preset depending on a user of the vehicle. The information providing method may further include transmitting, by the terminal, the content information for a specific user to the information processing device of the vehicle that is used by the specific user when communication is established with the vehicle that is used by the specific user.

According to the configuration described above, it is possible to provide the user with content information appropriate to the user.

In the first aspect, the information providing method may further include transmitting, by the information processing device, action record information indicating an action history of the specific user after acquisition of the content information to the terminal or the management server, and acquiring, by the terminal or the management server, the action record information of the specific user that is transmitted from the information processing device.

According to the configuration described above, it is possible to acquire information for measurement of an effect of distribution of the content information.

A second aspect of the present disclosure relates to an information providing system including a management server, a terminal including a storage, and an information processing device in a vehicle. The management server is configured to transmit content information indicating contents to the terminal. The terminal is configured to store the content information transmitted from the management server in the storage, and transmit, when communication is established with the vehicle, the content information stored in the storage to the information processing device of the vehicle. The information processing device is configured to receive the content information transmitted from the terminal, and output the received content information.

A third aspect of the present disclosure relates to a terminal in an information providing system including a management server, the terminal including a storage, and an information processing device in a vehicle. The terminal includes a terminal controller. The terminal controller is configured to receive content information indicating contents that is transmitted from the management server, store the received content information in the storage, and transmit, when communication is established with the vehicle, the content information stored in the storage to the information processing device of the vehicle.

According to the first aspect, the second aspect, and the third aspect of the present disclosure, it is possible to reduce the traffic between the vehicles and the management server when the management server transmits pieces of data to the vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic block diagram of an information providing system according to an embodiment;

FIG. 2 is a diagram illustrating an example of content information;

FIG. 3 is a diagram for describing an overview of the embodiment;

FIG. 4 is a diagram illustrating an example of the configuration of a computer of an on-board device that constitutes the information providing system;

FIG. 5 is a diagram illustrating an example of the configuration of a computer of each device that constitutes the information providing system;

FIG. 6 is a diagram illustrating an example of a processing routine to be executed in the information providing system;

FIG. 7 is a diagram illustrating an example of a processing routine to be executed in the information providing system;

FIG. 8 is a diagram illustrating an example of a processing routine to be executed in the information providing system; and

FIG. 9 is a diagram illustrating an example of a processing routine to be executed in the information providing system.

### DETAILED DESCRIPTION OF EMBODIMENTS

An information providing system of an embodiment is described below with reference to the drawings.

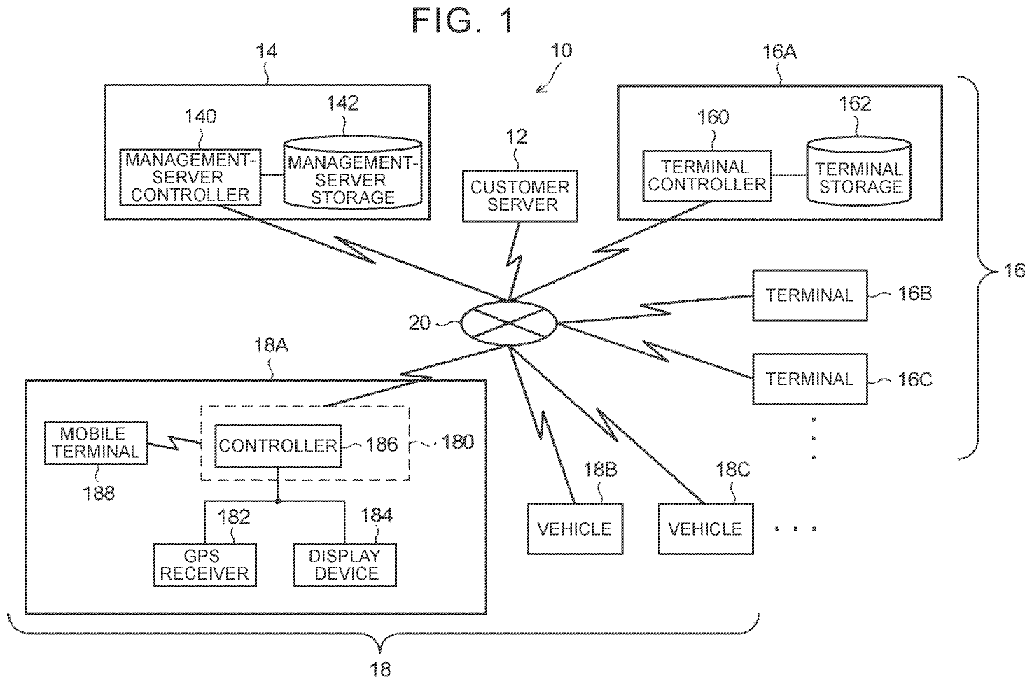

FIG. 1 is a block diagram illustrating an example of the configuration of an information providing system 10 according to this embodiment. As illustrated in FIG. 1, the information providing system 10 includes a customer server 12, a management server 14, a plurality of terminals 16A, 16B, and 16C, and a plurality of vehicles 18A, 18B, and 18C. The customer server 12, the management server 14, the terminals 16A, 16B, and 16C, and the vehicles 18A, 18B, and 18C are connected via a predetermined communication network 20.

Although FIG. 1 illustrates only the terminals 16A, 16B, and 16C, more terminals exist in actuality. Although FIG. 1 illustrates only the vehicles 18A, 18B, and 18C, more vehicles also exist in actuality.

In the following description, the suffixes A, B, and C are not assigned unless specific vehicles are described. For example, the vehicles 18A, 18B, and 18C are referred to simply as “vehicles 18” unless specific vehicles are described. Similarly, the suffixes A, B, and C are not assigned unless specific terminals are described. For example, the terminals 16A, 16B, and 16C are referred to simply as “terminals 16” unless specific terminals are described.

Customer Server

The customer server 12 provides the management server 14 with content information indicating predetermined contents. For example, the customer server 12 is managed by an organization that runs shops. Examples of the content information of this embodiment include advertisement information indicating an advertisement for the shops, and coupon information available in predetermined shops. The content information is provided for users of the vehicles. For example, the users who use the content information purchase goods in the shops.

The customer server 12 transmits, to the management server 14, the content information indicating contents such as a shop advertisement or a coupon. The content information is preset depending on the users of the vehicles. For example, the content information for each user is preset based on information acquired via an application installed in a mobile terminal 188 operated by the user.

For example, the content information for each user (for example, coupon information) is preset depending on whether information indicating a request for a coupon (for example, information indicating that the user wants a coupon) is set on the application. For example, in a case of a user who has used a restaurant A many times, coupon information or advertisement information of the restaurant A is preset as content information for the user.

Management Server

As illustrated in FIG. 1, the management server 14 functionally includes a management-server controller 140 and a management-server storage 142.

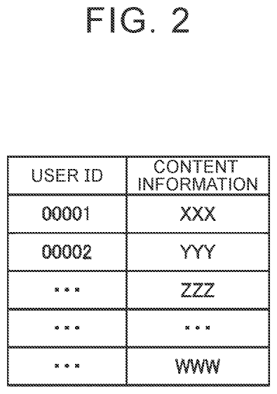

The management-server storage 142 stores pieces of content information preset depending on the users of the vehicles. The content information is transmitted from the customer server 12. FIG. 2 illustrates an example of the pieces of content information stored in the management-server storage 142. For example, the pieces of content information are stored in a table format as illustrated in FIG. 2. In the table illustrated in FIG. 2, a user identifier (ID) that is identification information for each user and content information for the user are stored in association with each other.

The management-server controller 140 transmits a plurality of pieces of content information stored in the management-server storage 142 to the terminals 16A, 16B, and 16C. Processes to be executed by the management-server controller 140 are described later in detail.

Terminals

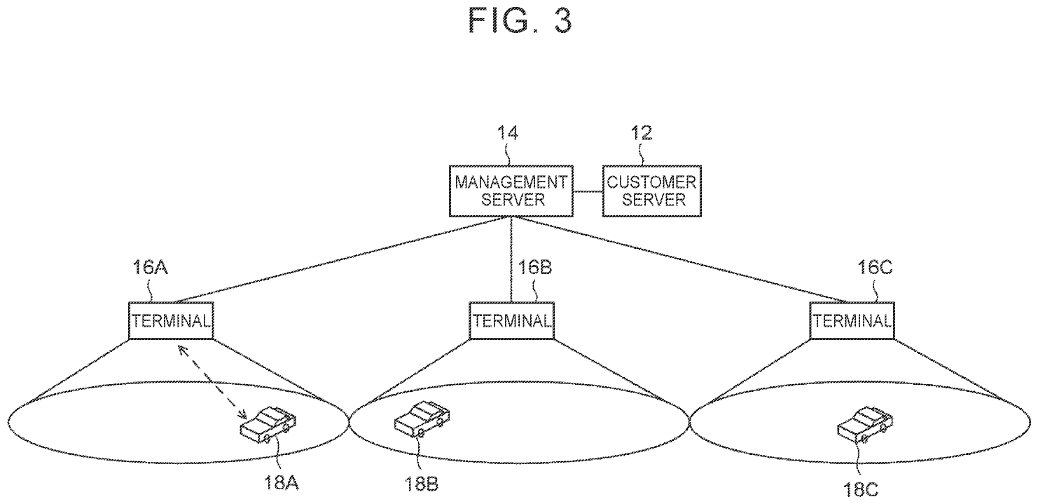

The terminals 16A, 16B, and 16C are arranged in individual places. FIG. 3 is a diagram for describing the arrangement of the terminals 16. As illustrated in FIG. 3, the terminals 16A, 16B, and 16C are arranged in preset ranges, for example, certain areas, respectively. For example, as illustrated in FIG. 3, when communication is established and authentication is completed between the terminal 16A and the vehicle 18A, content information for a user who is an occupant of the vehicle 18A is transmitted from the terminal 16A to the vehicle 18A. Thus, the vehicle 18A can receive the content information without exchanging information with the management server 14.

As illustrated in FIG. 1, the terminal 16 functionally includes a terminal controller 160 and a terminal storage 162.

The terminal storage 162 stores pieces of information similar to the pieces of content information stored in the management-server storage 142. The content information stored in the terminal storage 162 is available in an area where the terminal 16 is arranged. Examples of the content information include coupon information available in a shop in the area where the terminal 16 is arranged.

The pieces of content information stored in the terminal storage 162 are preset depending on the users of the vehicles. As illustrated in FIG. 2, the pieces of content information are stored in the terminal storage 162 in association with the user IDs.

The terminal controller 160 transmits content information for a specific user that is stored in the terminal storage 162 to an on-board device 180 mounted on a vehicle 18 of the specific user or a mobile terminal 188 of the user of the vehicle 18.

In this embodiment, the content information is prestored in the terminal storage 162 of each terminal 16. The terminal 16 that establishes communication with the on-board device 180 mounted on the vehicle 18 or the mobile terminal 188 of the user transmits the content information for the specific user to the on-board device 180 or the mobile terminal 188.

The content information may contain image information or the like, and the data amount tends to increase. In the information providing system 10 of this embodiment, the content information is temporarily stored in the terminal storage 162 of each terminal 16. When communication is established between the terminal 16 and the on-board device 180 or the mobile terminal 188 of any vehicle 18, the terminal 16 transmits the content information to the on-board device 180 or the mobile terminal 188. Therefore, there is no need for direct communication between the management server 14 and the vehicle 18. Thus, a traffic can be reduced. Since the content information for the specific user is transmitted from the terminal 16 to the on-board device 180 of the vehicle 18 of the specific user or the mobile terminal 188 of the specific user, the user is expected to purchase goods by using the content information. Processes to be executed by the terminal controller 160 are described later in detail.

Vehicles

As illustrated in FIG. 1, each vehicle 18 includes the on-board device 180, a global positioning system (GPS) receiver 182, a display device 184, and the mobile terminal 188 (for example, a smartphone) to be operated by the user of the vehicle. For example, the mobile terminal 188 and the on-board device 180 are connected through short-range communication such as Bluetooth (registered trademark).

The on-board device 180 or the mobile terminal 188 transmits information to and receives information from the terminals 16A, 16B, and 16C, and acquires content information transmitted from a certain terminal 16. The on-board device 180 or the mobile terminal 188 is an example of an information processing device of the present disclosure.

As illustrated in FIG. 1, the on-board device 180 functionally includes a controller 186.

The controller 186 exchanges information with the terminals 16, the GPS receiver 182, the display device 184, and the mobile terminal 188.

The GPS receiver 182 sequentially acquires pieces of positional information indicating the position of the vehicle 18.

The display device 184 outputs various types of information for the user who is an occupant of the vehicle 18.

The mobile terminal 188 is operated by the user in the vehicle 18. Examples of the mobile terminal 188 include a smartphone.

When content information for the user of the vehicle 18 is received from a certain terminal 16, the controller 186 of the on-board device 180 causes the display device 184 to display the content information. Alternatively, when content information for the user of the vehicle 18 is received from a certain terminal 16, the controller 186 of the on-board device 180 transmits the content information to the mobile terminal 188 connected through short-range communication such as Bluetooth (registered trademark). The user of the vehicle 18 views the transmitted content information by operating his/her mobile terminal 188.

Thus, the content information received by the vehicle 18 is used by the user of the vehicle 18. For example, when the content information is coupon information of a certain shop, the user purchases goods in the shop by using the coupon information.

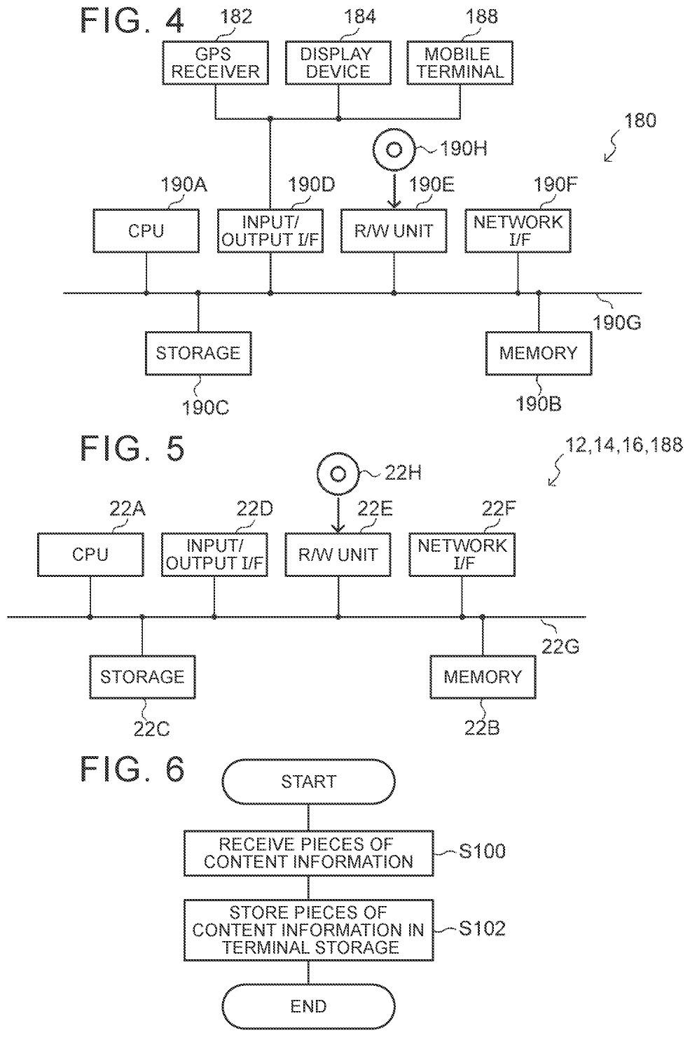

For example, the on-board device 180 of the vehicle 18 can be implemented by a computer illustrated in FIG. 4. As illustrated in FIG. 4, the computer includes a central processing unit (CPU) 190A, a memory 190B serving as a temporary storage area, and a non-volatile storage 190C. The computer further includes an input/output interface (I/F) 190D and a read/write (R/W) unit 190E. The GPS receiver 182, the display device 184, and the mobile terminal 188 are connected to the input/output I/F 190D. The R/W unit 190E controls data reading and writing for a recording medium 190H. The computer further includes a network I/F 190F connected to a network such as the Internet. The CPU 190A, the memory 190B, the storage 190C, the input/output I/F 190D, the R/W unit 190E, and the network I/F 190F are connected together via a bus 190G.

For example, the storage 190C can be implemented by a hard disk drive (HDD), a solid state drive (SSD), or a flash memory. The storage 190C serving as a storage medium stores programs for causing the on-board device 180 serving as the computer to exert its function. The CPU 190A reads the programs from the storage 190C, loads the programs on the memory 190B, and sequentially executes processes of the programs.

For example, each of the customer server 12, the management server 14, the terminals 16, and the mobile terminals 188 can be implemented by a computer illustrated in FIG. 5. As illustrated in FIG. 5, the computer includes a CPU 22A, a memory 22B serving as a temporary storage area, and a non-volatile storage 22C. The computer further includes an input/output interface (I/F) 22D and a read/write (R/W) unit 22E. An input/output device (not illustrated) is connected to the input/output I/F 22D. The R/W unit 22E controls data reading and writing for a recording medium 22H. The computer further includes a network I/F 22F connected to a network such as the Internet. The CPU 22A, the memory 22B, the storage 22C, the input/output I/F 22D, the R/W unit 22E, and the network I/F 22F are connected together via a bus 22G.

For example, the storage 22C can be implemented by a hard disk drive (HDD), a solid state drive (SSD), or a flash memory. The storage 22C serving as a storage medium stores programs for causing each device serving as the computer to exert its function. The CPU 22A reads the programs from the storage 22C, loads the programs on the memory 22B, and sequentially executes processes of the programs.

Next, actions of the information providing system 10 of the embodiment are described. When the information providing system 10 is activated and pieces of content information associated with the user IDs are transmitted from the management server 14 to the terminals 16, each of the terminals 16 executes a processing routine illustrated in FIG. 6.

In Step S100, the terminal controller 160 of the terminal 16 receives the pieces of content information from the management server 14. The terminal 16 receives the pieces of content information associated with the user IDs.

In Step S102, the terminal controller 160 of the terminal 16 stores, in the terminal storage 162, the pieces of content information received in Step S100. The pieces of content information are stored in the terminal storage 162 in association with the user IDs.

Through the processing routine of FIG. 6, the pieces of content information for the users are temporarily stored in the terminal 16.

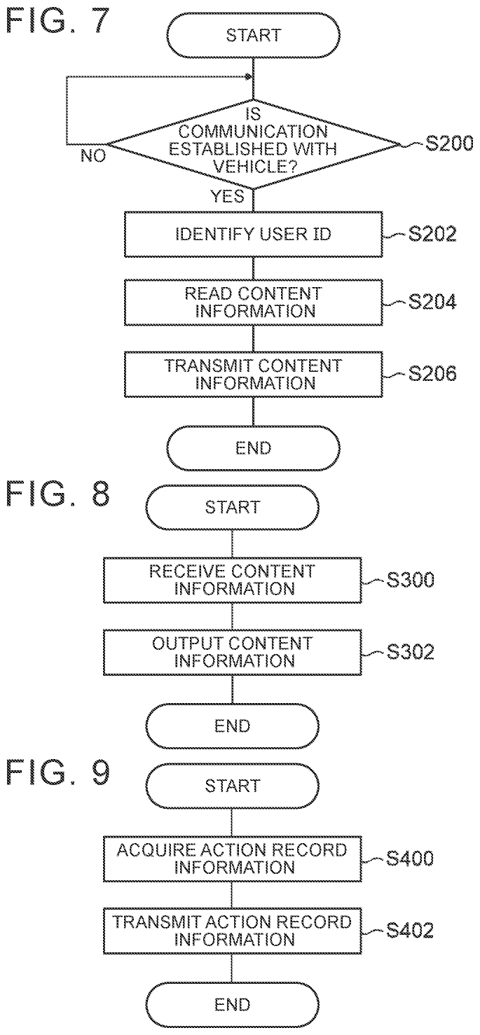

Next, each of the terminals 16 executes a processing routine illustrated in FIG. 7.

In Step S200, the terminal controller 160 of the terminal 16 determines whether communication is established with the on-board device 180 or the mobile terminal 188 of any one of the vehicles. When communication is established between the terminal 16 and any vehicle 18, the terminal controller 160 proceeds to Step S202. When communication is not established between the terminal 16 and any vehicle 18, the terminal controller 160 repeats the process of Step S200.

In Step S202, the terminal controller 160 of the terminal 16 executes authentication by identifying a user ID of the on-board device 180 of the vehicle 18 with which the communication is established, or the mobile terminal 188 operated by a user of the vehicle 18.

In Step S204, the terminal controller 160 of the terminal 16 reads, from the terminal storage 162, content information associated with the user ID identified in Step S202.

In Step S206, the terminal controller 160 of the terminal 16 transmits the content information read in Step S204 to the on-board device 180 of the vehicle 18 authenticated in Step S202, or to the mobile terminal 188 of the user of the vehicle 18.

When the content information is transmitted from the terminal 16 to the on-board device 180 of the vehicle 18 or the mobile terminal 188 of the user of the vehicle 18 through the processing routine of FIG. 7, the on-board device 180 of the vehicle 18 or the mobile terminal 188 of the user of the vehicle 18 executes a processing routine illustrated in FIG. 8. In the following description, the on-board device 180 executes the processing routine of FIG. 8.

In Step S300, the controller 186 of the on-board device 180 receives the content information transmitted from the terminal 16 in Step S206 of FIG. 7.

In Step S302, the controller 186 of the on-board device 180 outputs the content information received in Step S300 to the display device 184.

The display device 184 receives the content information output from the controller 186 of the on-board device 180, and displays the content information.

The mobile terminal 188 may execute the processing routine of FIG. 8.

The user who is an occupant of the vehicle 18 views the content information displayed on the display device 184. For example, the content information is a coupon available in an area where the terminal 16 is arranged. In this case, for example, the user views the coupon, and purchases goods in a shop where the coupon is available.

The controller 186 of the on-board device 180 may output the content information to the mobile terminal 188 operated by the user by using, for example, short-range communication. In this case, the user views the content information transmitted to his/her mobile terminal 188, and purchases goods by using the mobile terminal 188 in the shop where the coupon is available.

When the user who has viewed the content information takes an action such as purchase, the on-board device 180 or the mobile terminal 188 executes a processing routine illustrated in FIG. 9.

In Step S400, the on-board device 180 or the mobile terminal 188 acquires action record information indicating an action history of the specific user after the acquisition of the content information. For example, when the content information is coupon information, the action record information indicates that the user has used the coupon information. For example, when the content information is advertisement information, the action record information indicates that the user has visited a shop shown in the advertisement information. For example, the information indicating that the user has visited the shop is acquired by the GPS receiver 182.

In Step S402, the on-board device 180 or the mobile terminal 188 transmits the action record information acquired in Step S400 to the management server 14 or to the terminal 16 that has transmitted the content information.

The terminal 16 or the management server 14 acquires the action record information of the specific user that is transmitted from the on-board device 180 or the mobile terminal 188. The action record information is used for determining content information to be sent to the specific user next time.

The information indicating a record of use of content information by the user may be transmitted to the customer server 12 via the terminal 16 or the management server 14.

As described above, the management server of the information providing system according to this embodiment transmits pieces of content information indicating contents to the terminals. Each of the terminals stores the pieces of content information transmitted from the management server in the content information storage. When communication is established with any vehicle, the terminal transmits the content information stored in the content information storage to the on-board device or the mobile terminal of the vehicle. The on-board device or the mobile terminal of the vehicle receives the content information transmitted from the terminal, and outputs the received content information. Thus, when pieces of data are transmitted from the management server to the vehicles, the traffic between the vehicles and the management server can be reduced. Further, the management server need not transmit information to and receive information from the vehicles, and when communication is established between the terminal and any vehicle, the terminal transmits the content information to the vehicle. Thus, the terminal can transmit the content information to the vehicle without using positional information of the vehicle.

Since the management server need not transmit information to and receive information from the vehicles, a processing load on the management server is reduced. Further, the degree of real-time communication can be improved because the physical distance between the terminal and the vehicle is short. Therefore, after viewing the content information, the user of the vehicle can promptly take an action by using the content information. For example, the user can purchase goods in a nearby shop by using coupon information that is an example of the content information.

The content information for the specific user is transmitted to the on-board device or the mobile terminal of the vehicle of the specific user. Therefore, it is possible to provide the user with content information appropriate to the user.

The action record information indicating the action history of the specific user after the acquisition of the content information is transmitted to the terminal or the management server. Therefore, it is possible to acquire information for measurement of an effect of distribution of the content information.

The processes to be executed by the individual devices of the embodiment are described as the software processes to be executed by executing the programs, but may be processes to be executed by hardware. Alternatively, the processes may be executed by software and hardware in combination. The programs to be stored in the ROM may be distributed by being stored in various storage media.

The present disclosure is not limited to the embodiment described above, but various other modifications may be made without departing from the spirit of the present disclosure.

What is claimed is:

1. An information providing method to be executed in an information providing system including a management server, a terminal including a storage, and an information processing device in a vehicle, the information providing method comprising:
transmitting, by the management server, content information indicating contents to the terminal;
storing, by the terminal, the content information transmitted from the management server in the storage;
transmitting, by the terminal, the content information stored in the storage to the information processing device of the vehicle when communication is established with the vehicle;
receiving, by the information processing device, the content information transmitted from the terminal; and
outputting, by the information processing device, the received content information.

2. The information providing method according to claim 1, wherein the content information stored in the storage of the terminal is available in an area where the terminal is arranged.

3. The information providing method according to claim 1, further comprising transmitting, by the terminal, the content information for a specific user to the information processing device of the vehicle that is used by the specific user when communication is established with the vehicle that is used by the specific user, wherein
the content information is preset depending on a user of the vehicle.

4. The information providing method according to claim 3, further comprising:
transmitting, by the information processing device, action record information indicating an action history of the specific user after acquisition of the content information to the terminal or the management server; and
acquiring, by the terminal or the management server, the action record information of the specific user that is transmitted from the information processing device.

5. An information providing system comprising:
a management server;
a terminal including a storage; and
an information processing device in a vehicle, wherein
the management server is configured to transmit content information indicating contents to the terminal,
the terminal is configured to
store the content information transmitted from the management server in the storage, and
transmit, when communication is established with the vehicle, the content information stored in the storage to the information processing device of the vehicle, and
the information processing device is configured to
receive the content information transmitted from the terminal, and
output the received content information.

6. A terminal in an information providing system including a management server, the terminal including a storage, and an information processing device in a vehicle, the terminal comprising a terminal controller configured to:
receive content information indicating contents that is transmitted from the management server;
store the received content information in the storage; and
transmit, when communication is established with the vehicle, the content information stored in the storage to the information processing device of the vehicle.
